(19) United States
(12) Patent Application Publication
(10) Pub. No.: US 2004/0122955 A1
(43) Pub. Date: Jun. 24, 2004

(54) Remote control system using web and icon

(76) Inventor: Hea-Sun Park, Seoul (KR)

Correspondence Address: Peter T. Kwon, GWiPS, Kangnam, P.O. Box 2301, Seoul, 135-242, KR

(21) Appl. No.: 10/695,989

(22) Filed: Oct. 30, 2003

(30) Foreign Application Priority Data
Nov. 22, 2002 (KR) 2002-0072969

(51) Int. Cl. G06F 15/16

(52) U.S. Cl. 709/227

(57) ABSTRACT

A remote control system using the Internet is disclosed. According to the remote control system, a user can connect with the computer in charge of control without inputting information required for the connection by clicking an object such as an icon, an avatar or a hyper-link produced on the web page so that the control computer can remotely control the user's computer. Accordingly, even general users who are not skilled in using the Internet can be easily provided with remote control service through the Internet. Furthermore, in the case where high level security is required, such as finance, administration, e-commerce and so on, the user is confirmed through two steps by telephone as well as the access password so that high level security can be guaranteed.

### BACKGROUND OF THE INVENTION

1. Field of the Invention

The present invention relates to a computer remote control system using the Internet and, more particularly, to a computer remote control system using webs and icons, in which a user of a computer that is the object of control clicks an object such as an icon, avatar or hyper-link displayed on a web page to achieve connection for control without inputting information required for control every time.

2. Description of the Prior Art

In general, a computer remote control system using the Internet employs a client/server model in which a server processes a clients' request where a manager that is the subject of control remotely controls a to-be-controlled computer. Specifically, a manager computer in which a client program is installed requests the to-be-controlled computer in which a server program is executed to control the to-be-controlled computer, and then the to-be-controlled computer permits the manager computer to connect thereto. By doing so, the manager computer controls the to-be-controlled computer. The computer in charge of the control operates as the client and the to-be-controlled computer operates as the server.

This remote control is carried out between general users and consultants of Internet Service Providers (ISP) or providers that provide various services such as finance and electronic commerce on the Internet. Since the general user's computer serve as a client normally, the client program and server program must be installed in the user's computer and an consultant's computer, respectively, and required environments must be set for the remote control, which is a cumbersome process.

For exchange of files between the subject of control and the object of control, there was used a method that a file server or a data server provides data to clients one-sidedly or a Peer-to-Peer model in which a transmitter and a receiver directly exchange data with each other as a server and a client using fixed Internet protocol (IP) addresses. The former one cannot easily access systems in the case where it does not have an account with the same network or server. The latter has vulnerability of security due to direct connection and encounters an obstacle according to a security system such as Firewall.

To solve these problems, the present applicant proposed a remote control system in Korean patent Application No. 2001-0068939 entitled “Improved remote control system on the Internet” which was filed on Nov. 6, 2001. In this remote control system, a consultant's computer that is the subject of control remotely controls a user's computer that is the object of control in such a manner that the consultant's computer and user's computer are authenticated by a separate authentication server and they download web objects, and then the user's computer requests the consultant's computer to remotely control itself. In addition, the same applicant also proposed Korean Patent Application No. 2002-0014773 entitled “File exchange system through a gateway server” which was filed on Mar. 19, 2002. In this system, a transmitter and a receiver are not connected to each other as a server and a client but both of them connect with a gateway server existing on a network as clients to exchange files and data with each other.

With these techniques, remote control can be easily carried out without installing the server program and client program. Furthermore, the consultant's computer cannot access the user's computer unless the user's computer that is the object of control requests the consultant's computer to control it and invests the consultant's computer with authority to control the user's computer. Thus, high level security can be guaranteed. Moreover, data can be exchanged without encountering an obstacle caused by a security system on the network even without having a fixed IP address. However, a user suffers from an inconvenience of having to know the IP address and service port of the server or client or being informed of them through a communication means like telephone. Also, the user should input the information to his/her system one by one.

In the case where the user's computer or program has a trouble so that a consultant remotely connects with the user's computer to grasp the cause of the trouble to solve it, especially, the method that the user is informed of the IP address and service port of the consultant to connect with the consultant through them is difficult for general users who have poor knowledge of computer to practically use.

### SUMMARY OF THE INVENTION

Accordingly, the present invention has been made in view of the above problems, and an object of the present invention is to provide a remote control system through the Internet in which a web page used for consultation guide and inducement of connection between an consultant's computer that is the subject of the control and a user's computer that is the object of control is constructed and an object such as an icon, an avatar or a hyper-link that represents a consultant is produced on the web page such that the user clicks the icon, avatar or hyper-link to connect with the consultant's computer through the IP address and service port of the corresponding consultant without inputting information required for the connection every time. Accordingly, the consultant's computer can connect with the user's computer easily and conveniently.

To accomplish the above object, according to the present invention, there is provided a

Furthermore, a viewer, a program that receives image data of the user's computer screen and displays it on the consultant's computer, is installed in the consultant's computer so that the consultant can remotely control the user's computer while watching the user's computer screen in real time. Moreover, the remote control system of the present invention includes a user authentication procedure for inactivating the icon of the corresponding consultant, displayed on the web page, at the same time when connection between the consultant's computer and user's computer is attempted and preventing a third person from arbitrarily connecting with the consultant's computer while the consultants' computer connects with the user's computer to remotely control it. This can guarantee high level security.

### BRIEF DESCRIPTION OF THE DRAWINGS

Further objects and advantages of the invention can be more fully understood from the following detailed description taken in conjunction with the accompanying drawings, in which:

FIG. 1 shows the concept of the present invention.

FIG. 2 is a flow chart for explaining the present invention.

FIG. 3 is a flow chart for showing a double security user authentication procedure of the present invention.

FIG. 4 shows states of the viewer and icon by steps in the present invention.

FIG. 5 shows states of a screen in the event of remote control according to the present invention.

FIG. 6 shows a password input picture according to the present invention.

FIG. 7 shows a password input picture for double security according to the present invention.

### DETAILED DESCRIPTION OF THE INVENTION

Reference will now be made in detail to the preferred embodiments of the present invention, examples of which are illustrated in the accompanying drawings.

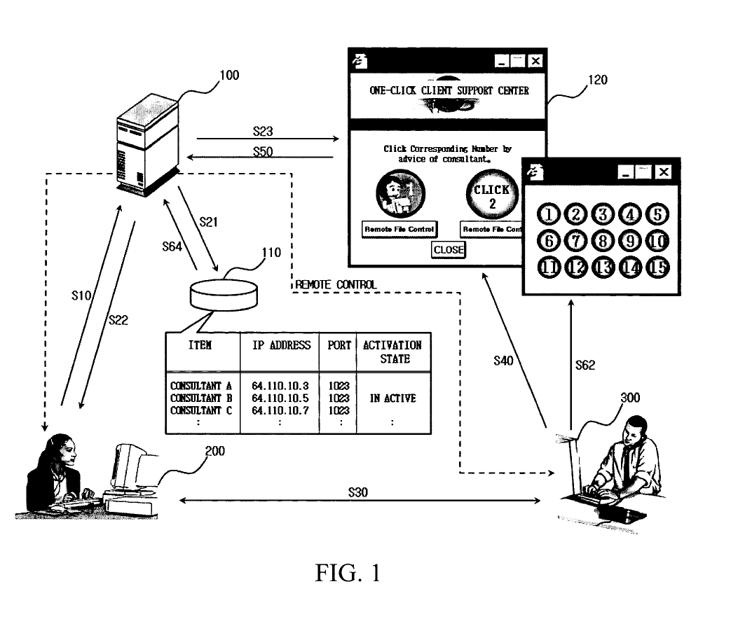

As shown in FIG. 1, the remote control system according to the present invention includes a consultant's computer 200 that is the subject of control, a user's computer 300 that is the object of control, a relay server 100, an authentication database 110, and a web page 120. Remote control through the system of the present invention is carried out through the following procedure.

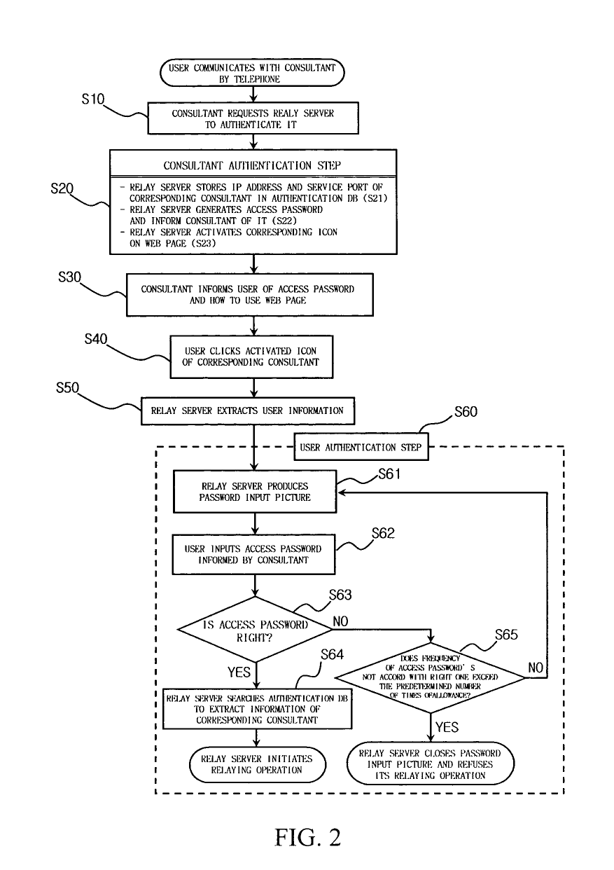

Referring to FIG. 2, when a user requests a consultant to help him or her by telephone, first of all, the consultant transmits connection information such as the IP address and service port of the consultant's computer 200 to the relay server 100 and requests the relay server to authenticate the consultant's computer, at the step 20. At the step 20, the relay server 100 stores the connection information of the consultant in the authentication DB 110 (S21), generates an access password to deliver it to the consultant's computer 200 (S22), and activates an icon of the consultant, displayed on the web page 120 (S23).

The consultant, who has received the access password from the relay server 100 guides the user in using of the web page 120 and, at the same time, informs the user of the access password at the step S30. The user clicks the activated icon of the consultant, displayed on the web page 120, using a browser of the user's computer 300 at the step S40. Here, the icon of each consultant does not directly include access information such as the IP address of the consultant's computer 200 but has only the ID of the corresponding consultant who requests the relay server 100 to connect thereto. When the user clicks the icon, the ID included in the corresponding icon and the IP address of the user's computer 300 is transmitted to the relay server 100.

When the user clicks the icon, it is inactivated and the relay server 100 extracts the connection information such as the IP address of the user's computer 300 at the step S50. Then, at the user authentication step S60, the relay server produces a password input picture on the screen of the user's computer 300 (S61). An example of the password input picture is shown in FIG. 6.

When the user inputs the access password informed by the consultant to the password input picture at the step S62, the relay server 100 judges whether the access password is right or not, at the step S53. In case of right password, the relay server extracts the connection information of the corresponding consultant from the authentication DB 110 using the received ID at the step S64, to connect the consultant's computer with the user's computer through a packet switching method that switches a packet transmitted from the IP address of the user's computer 300. In the case where the frequency of the inputted passwords not accord with the right exceeds the predetermined number of times of allowance (S65), the relay server 100 closes the password input picture and refuses its relay operation.

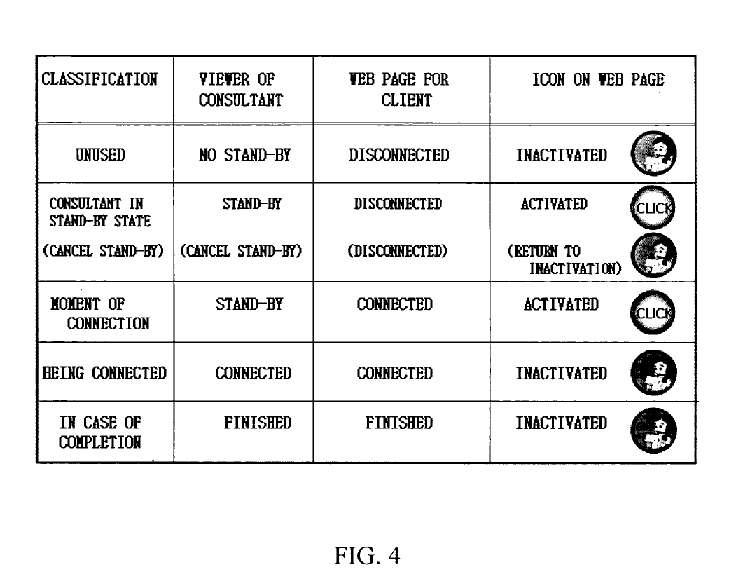

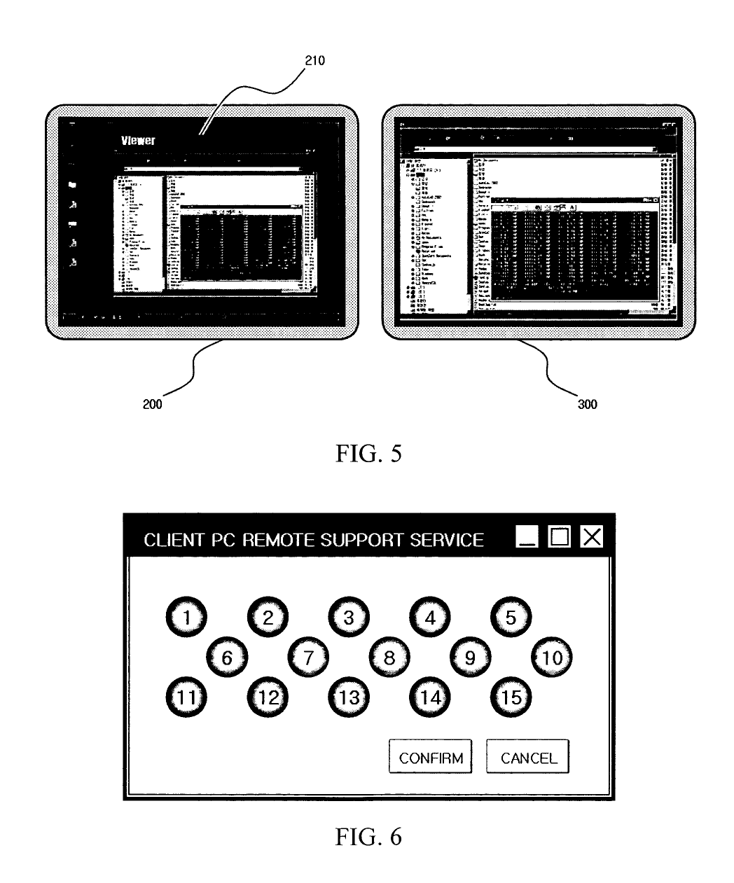

A viewer 210, a program that receives image data from the user's computer 300 and displays it on the screen of the consultant's computer 200, is installed in the consultant's computer 200. Accordingly, when the relay server 100 initiates its relay operation to achieve remote control, the consultant can remotely control the user's computer 300 while watching the screen of the user's computer in real time. The icon displayed on the web page 120 is in an inactivate state normally and, when the consultant requests the relay server 100 to authenticate it, it is activated to become a connection waiting state. The icon is inactivated again when the user clicks it to attempt to connect with the consultant's computer. Statuses of the viewer 210 and icon by connection steps and statuses of the screen in the event of remote control are shown in FIGS. 4 and 5, respectively.

The icon of each consultant, displayed on the web page 120, does not have direct connection information such as the IP address of the consultant's computer 200 but has only ID used for the authentication DB 110 to search the connection information of the corresponding consultant's computer 200. Thus, even if an ill-intentioned user attempts hacking, the system is safe in terms of security because the ill-intentioned user does not have the information of the consultant's computer 200. Furthermore, while the consultant's computer 200 connects with the user's computer 300 to remotely control the user's computer or when the connection is finished, the icon on the web page 120 becomes the inactivate state where the icon cannot be clicked so that an unspecified user who visits the web page 120 cannot arbitrarily connect with the consultant's computer.

Moreover, in order to block arbitrary connection during a short period of time for which the icon is activated while the consultant is waiting for connection, the user inputs the password informed by the consultant to the web page 120 such that the relay server 100 confirms it.

This password confirmation procedure is carried out in such a manner that the relay server 100 creates a password using random numbers to transmit it to the consultant's computer 200, the consultant informs the user of the password by telephone, and the user inputs the password such that the relay server 100 identifies the user through the password. The user clicks an iconized symbol or figure or directly inputs the password to the password input picture using keys. Especially, the method of clicking the iconized symbol or figure is very convenient for users who are not skilled in using the keys.

Although the above-described method is convenient, a figure or character string that constructs the password is short because the consultant should inform the user of the password verbally and the user should remember and input the password. In addition, the method of clicking the iconized symbol or figure cannot guarantee perfect security because there is a limitation in the number of icons which can be produced on one screen.

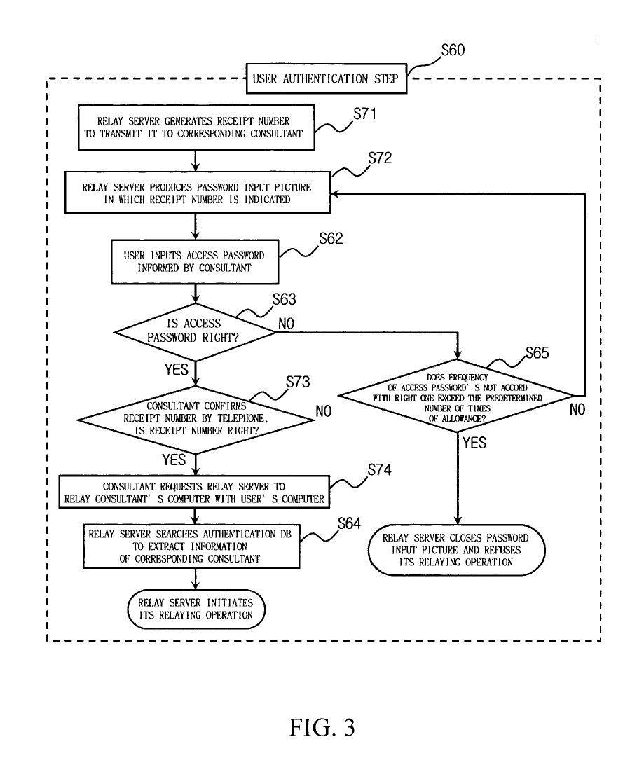

In the case where high level security is needed, such as finance, administration, e-commerce and so on, accordingly, user identification is executed through two steps in user authentication procedure, as shown in FIG. 3, to increase security level. The detailed procedure is as follows.

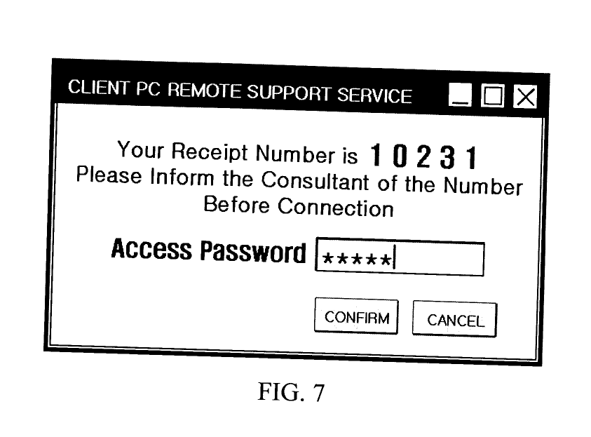

When the user who has been informed of the password by the consultant clicks the icon of the consultant, displayed on the web page 120, so that the ID of the consultant and IP address of the user' computer 300 are transmitted to the relay server 100, the relay server 100 generates a receipt number to deliver it to the corresponding consultant's computer 200 at the step S71, and produces a password input picture in which the receipt number is indicated on the screen of the user's computer at the step S72. An example of the password input picture in which the receipt number is displayed is shown in FIG. 7.

When the user inputs the password to the password input picture at the step S62, the relay server 100 confirms it at the step S63 and, when the password is right, informs the consultant of this fact. When the password does not accord with the right one in excess of the predetermined number of times of allowance (S65), the relay server closes the password input picture and refuses its relay operation.

When the user informs the consultant who has been informed that the password is right of the receipt number on the password input picture verbally, the consultant confirms it at the step S73. When the receipt number is right, the consultant requests the relay server to relay the consultant's computer with the user's computer at the step S74. The relay server 100 searches the authentication DB 110 for connection information of the corresponding consultant to connect the consultant's computer with the user's computer, at the step S64.

The remote control system using a web and an icon according to the present invention includes the consultant's computer 200 that is the subject of control, the user's computer 300 that is the object of control, the relay server 100 for relaying the control procedure, the authentication DB 110 that manages connection information of the consultant's computer 200, and a web page 120 for inducing connection of the user's computer 200. In the remote control system, the relay server 100 connects the consultant's computer that is the subject of control with the user's computer that is the object of control through the packet switching method to remotely control the user's computer through a consultant authentication request step S10 in which the consultant transmits consultant connection information including the IP address and service port of the consultant's computer 200 to the relay server 100 and requests the relay server to authenticate the consultant's computer; a consultant authentication step S20 including a sub-step S21 in which the relay server 100 stores the connection information including the IP address and service port of the consultant in the authentication DB 100, a sub-step S22 in which the relay server 100 generates an access password and transmits it to the consultant's computer 200 to inform the consultant's computer of it, and a sub-step S23 for activating an icon including the ID of the consultant on the web page 120; an access password informing step S30 in which the consultant informs the user of the access password and how to use the web page 120 by telephone; an icon clicking step S40 in which the user confirms the web page 120 using a browser of the user's computer and clicks the icon indicating the consultant; a user information extracting step S50 in which the relay server 100 extracts user connection information including the IP address of the user's computer and consultant ID included in the icon to memorize them, and inactivates the icon of the consultant on the web page 120, clicked by the user; and a user authentication step S60 including a sub-step S61 in which the relay server 100 produces a password input picture on the user's computer 300, a sub-step S62 in which the user inputs the access password informed by the consultant to the password input picture, a sub-step S63 in which the relay server 100 confirms whether the access password is right or not, and a sub-step S64 in which the relay server 100 searches the authentication DB 110 for connection information of the consultant's computer 200 when the inputted password is right.

The user authentication step S60 may include a receipt number generating step S71 in which the relay server 100 generates a receipt number to transmit it the consultant's computer 200; a receipt number transmission step S72 in which the relay server 100 produces a password input picture where the receipt number is indicated on the user's computer 300; an access password inputting step S62 in which the user inputs the access password informed by the consultant to the password input picture; an access password confirmation step S63 in which the relay server 100 confirms whether the access password is right or not; a receipt number confirmation step S73 in which, when the password is right, the relay server 100 informs the consultant of it so that the consultant can confirm the receipt number by telephone; and an relay request step S74 in which the consultant requests the relay server 100 to relay the consultant's computer and user's computer with each other when the receipt number is right.

A viewer 210, a program that receives image data from the user's computer 300 to display it on the screen of the consultant's computer 200, is installed in the consultant's computer 200 so that the consultant can confirm the screen of the user's computer 300 while remotely controlling it.

As described above, according to the present invention, the user can connect with the computer in charge of control without inputting information required for the connection by clicking an object such as an icon or an avatar produced on the web page so that the control computer can remotely control the user's computer. The icon on the web page is inactivated at the same time when the connection is attempted, and the user is identified using an access password to block a third person from arbitrarily connecting with the control computer while the user is connecting to the control computer.

According to the present invention, even general users who are not skilled in using the Internet can be easily provided with remote control service through the Internet. Furthermore, in the case where high level security is required, such as finance, administration, c-commerce and so on, the user is confirmed through two steps by telephone as well as the access password so that high level security can be guaranteed.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A remote control system using webs and icons, comprising:
a consultant's computer (200) that is the subject of control;
a user's computer (300) that is the object of control;
a relay server (100) for relaying a control procedure;
an authentication DB (110) that manages connection information of the consultant's computer (200); and
a web page (120) for inducing connection of the user's computer (200),
wherein the relay server (100) connects the consultant's computer with the user's computer through a packet switching method to remotely control the user's computer through a consultant authentication request step (S10) in which the consultant transmits consultant connection information including the IP address and service port of the consultant's computer (200) to the relay server (100) and requests the relay server to authenticate the consultant's computer;
a consultant authentication step (S20) including a sub-step (S21) in which the relay server (100) stores the connection information including the IP address and service port of the consultant's computer (200) in the authentication DB (110), a sub-step (S22) in which the relay server (100) generates an access password and transmits it to the consultant's computer (200) to inform the consultant's computer of it, and a sub-step (S23) for activating an icon including the ID of the consultant on the web page (120);
an icon clicking step (S40) in which the user clicks the icon that represents the consultant on the web page (120) through a browser of the user's computer;
a user information extracting step (S50) in which the relay server (100) extracts user connection information including the IP address of the user's computer and consultant ID included in the icon to memorize them, and inactivates the icon of the consultant on the web page (120), clicked by the user; and
a user authentication step (S60) including a sub-step (S61) in which the relay server (100) produces a password input picture to which the user will inputs the access password informed by the consultant, on the user's computer (300), a sub-step (S63) in which the relay server (100) confirms whether the access password is right or not, and a sub-step (S64) in which the relay server (100) searches the authentication DB (110) using the consultant ID to extract connection information of the consultant's computer (200) when the inputted password is right.

2. The remote control system as claimed in claim 1, wherein the user authentication step (S60) comprises:
a receipt number generating step (S71) in which the relay server (100) generates a receipt number to transmit it the consultant's computer (200);
a receipt number transmission step (S72) in which the relay server (100) produces a password input picture where the receipt number is indicated, on the user's computer (300);
an access password inputting step (S62) in which the user inputs the access password informed by the consultant to the password input picture;
an access password confirmation step (S63) in which the relay server (100) confirms whether the access password is right or not;
a receipt number confirmation step (S73) in which, when the password is right, the relay server (100) informs the consultant of it so that the consultant can confirm the receipt number by telephone; and
a relay request step (S74) in which the consultant's computer requests the relay server (100) to relay the consultant's computer and user's computer with each other when the receipt number is right.

3. The remote control system as claimed in claim 1, wherein a viewer (210), a program that receives image data from the user's computer (300) to display it on the screen of the consultant's computer (200), is installed in the consultant's computer (200) so that the consultant can confirm the screen of the user's computer (300) while remotely controlling it
